(19) United States
(12) Patent Application Publication
(10) Pub. No.: US 2009/0006180 A1
(43) Pub. Date: Jan. 1, 2009

(54) Multiple application advertising

(76) Inventor: Tapio Hameen-Anttila, Espoo (FI)

Correspondence Address: Hollingsworth & Funk, LLC, 8009 34th Avenue South, Suite 125, Minneapolis, MN, 54425, US

(21) Appl. No.: 11/823,323

(22) Filed: Jun. 27, 2007

(51) Int. Cl. G06Q 30/00; G06Q 99/00

(52) U.S. Cl. 705/10

(57) ABSTRACT

Two or more user applications running on a single mobile device are capable of showing advertising materials. Usage information is collected from the user applications. The usage information tracks exposure to the advertising materials associated with each of the user application. A polling message from a server is received at the mobile device at a predetermined interval via a tracking application of the mobile device. A per-application summary of the usage information is sent from the device in response to the polling message.

### FIELD OF THE INVENTION

This invention relates in general to computerized advertising, and more particularly to placing advertising on mobile computing devices.

### BACKGROUND OF THE INVENTION

Advertising via the Internet is becoming more important to many businesses. Internet advertising has some advantages and some disadvantages relative to traditional forms of advertising. For example, one of the disadvantages is that banner advertisements in Web pages are easily ignored (or removed completely from display), and this makes them less effective than advertisements in broadcast mediums such as radio. On the other hand, when advertising is tailored to take advantage of unique conditions created by the Internet, such advertising can be very effective. An example is targeted ads that are displayed in conjunction with search results (e.g., sponsored links). Although these ads may be as easily ignored as a banner ad, they are shown to the user at a time when they may actually be interested in making a purchase Thus user interaction with search engine sponsored links are much higher than banner ads displayed with other Web content.

A growing population of users is accessing the Internet and other data services via mobile devices such as cellular phones, personal digital assistants (PDS), and ultra-mobile personal computers (UMPC). In many ways, mobile advertisers currently use techniques similar to those established by Internet online advertisers. Device manufacturers and service providers act as intermediaries connecting advertisers with mobile publishers who wish to build revenue with advertising. Similar to computer manufacturers and software developers, mobile providers have some control the user experience, and may include some amount of advertising as part of that experience. This type of placement is seen where vendors have included product placements in the device configurations when the devices are first delivered to the users.

Mobility brings great opportunity to advertisers, but at the same time there are several problems in the mobile environment that are not necessarily seen with Internet online advertisement. Generally, Internet connected computers such as desktop and laptop personal computers (PC) can remain online the entire time they are in use. In that environment, most Internet advertisement is directed to online applications, such as web browsers and email. However, a mobile device generally operates in an environment where network connectivity is a relative unknown. Connectivity may or may not be available, and the form and quality of such connectivity may vary depending on location and time.

Unlike traditional Internet advertising, which is directed primarily PC users, devices in the mobile environment may not be presumed to be connected to Internet at any fixed point in space or time. Further, the applications that carry the advertising may be used frequently or non-frequently. The use of a particular application may vary greatly from user to user, device to device, and provider to provider. This makes advertising campaign management in the mobile communications world complex.

Mobile terminals may provide an interesting and profitable entry point for advertisers. However, an easier way is needed to manage the various aspects of mobile advertising is desirable. Such management may need to take into account variables such as different kind of networks, capacities, operator networks, language issues, multiple applications used on a terminal, terminal capabilities and the normal, daily-basis problems inherent in the mobile environment.

### SUMMARY OF THE INVENTION

To overcome limitations in the prior art described above, and to overcome other limitations that will become apparent upon reading and understanding the present specification, the present invention discloses a system, apparatus and method for associating peer contribution credits with multiple devices. In accordance with one embodiment of the invention, a method involves collecting usage information from two or more user applications running on a single mobile device. The usage information tracks exposure to advertising materials associated with each of the user applications. A polling message is received from a server at a predetermined interval relative to a critical reporting time via a tracking application of the mobile device, and a per-application summary of the usage information is sent from the mobile device in response to the polling message. The critical reporting time indicates a predetermined milestone in an advertising campaign that uses the advertising materials.

In more particular embodiments, the usage information is collected during a predetermined time period after a start of an advertising campaign directed to mobile devices. The usage information may include a service identifier that indicates a service used by the user applications, an ad identifier that indicates an advertisement associated with the service, a time of user exposure to the advertisement, and/or a time that the device connects to an ad server to upload usage data. In such a case, the method further involves collecting the usage information from a plurality of users and determining usage statistics for the service identifier using the usage information from the plurality of users. In addition, the usage data of the plurality of users may be estimated based on previous user interaction with the service indicated by the service identifier.

In more particular embodiments where usage data is estimated, the method may involve defining a critical reporting time based on the estimated usage data and stopping an advertising campaign based on the critical time. The critical reporting time indicates a time past which there is a change in likelihood of collecting additional usage data. Defining the critical reporting time comprises defining the critical reporting time as a time when 80% of the usage data of all users will be collected. In one arrangement, defining the critical reporting time may involve defining a plurality of critical reporting times, each critical reporting time associated with a different demographic. In such a case, stopping the advertising campaign based on the critical time may involve stopping each of the plurality of critical reporting times based on a different criteria associated with each of the plurality of critical reporting times.

In other more particular embodiments where usage data is estimated, the method may involve defining a critical reporting number based on the estimated usage data and stopping an advertising campaign based on collecting the usage data from a number of users that satisfies the critical reporting number. In such a case, defining the critical reporting number based on the estimated usage data may involve defining a plurality of critical reporting numbers each associated with separate demographics. The advertising campaign may be stopped based on receiving usage data from a number of users of each of the demographics that satisfies the associated critical reporting number.

In other more particular embodiments of the method, the usage data includes at least one of country identifier and language identifier of the mobile device. The usage data may also include a terminal model identifier, and the at least one of the user applications may include a computer game.

In another embodiment of the present invention, a mobile device includes a network interface capable of connecting to a network and a processor coupled to the network interface. Memory is coupled to the processor, and the memory includes a plurality of user applications and an ad engine. The ad engine has instructions that causes the processor to perform steps that include a) causing the user applications to render advertising materials to a user of the device; b) collecting usage information via the user applications, the usage information tracking exposure to the advertising materials associated with each of the user applications; c) receiving a polling message via the network at a predetermined interval relative to a critical reporting time; and d) sending a per-application summary of the usage information from the device in response to the polling message.

In more particular embodiments, the usage information may include: a) a service identifier that indicates services used by the user applications, b) an ad identifier that indicates an advertisement associated with the service, and c) a time of user exposure to the advertisement. The usage data may also include at least one of country identifier, language identifier and/or a terminal model identifier. At least one of the user applications may include a computer game.

In another embodiment of the present invention, a computer-readable storage medium has instructions executable by a processor of a mobile device for performing steps that include: a) causing two or more user applications of the mobile device to render advertising materials to a user of the device; b) collecting usage information via the user applications, wherein the usage information tracks user exposure to the advertising materials associated with each of the user applications; c) receiving a polling message via the network at a predetermined interval relative to a critical reporting time; and d) sending a summary of the usage information from the device in response to the polling message.

In another embodiment of the present invention, a system includes a network and a plurality of mobile terminals. Each terminal includes a processor, a plurality of user applications, and an ad engine. The ad engines cause the processors to: a) cause the user applications to render advertising materials to a user of the device; b) collect usage information via the user applications, wherein the usage information tracks exposure to the advertising materials associated with each of the user applications; d) receive a polling message via the network at a predetermined interval; and d) send a summary of the usage information from the device in response to the polling message. The system further includes an ad server having a processor and instructions that cause the processor to perform steps that include: a) sending the advertising materials to the mobile terminals via the network; b) collecting the summaries of the usage information from the mobile terminals; and c) determining usage statistics related to the advertising materials using the summaries.

In more particular embodiments of the system, the mobile terminals collect the usage information during a predetermined time period after a start of an advertising campaign directed to the mobile terminals. The usage information may include a service identifier that indicates a service used by the user applications, an ad identifier that indicates an advertisement associated with the service, and a time of user exposure to the advertisement. The ad server may include instructions that further cause the processor to estimate the usage data of the plurality of mobile terminals based on previous user interaction with one or more of the user applications.

In other more particular embodiments, the ad server has instructions that further cause the processor to: a) define a critical reporting number based on the estimated usage data; and b) direct the mobile terminals to stop an advertising campaign based on collecting the usage data from a number of users that satisfies the critical reporting number. In one arrangement, defining the critical reporting number based on the estimated usage data involves defining a plurality of critical reporting numbers each associated with separate demographics, and the advertising campaign is stopped based on receiving usage data from a number of users of each of the demographics that satisfies the associated critical reporting number.

In another embodiment of the invention, a system includes: a) means for sending advertising materials to a plurality of mobile terminals via the network; b) means for causing a plurality of user applications of the mobile terminals to render the advertising materials to users of the mobile terminals; c) means for collecting usage information via the user applications, wherein the usage information tracks exposure to the advertising materials associated with each of the user applications; d) means for sending a polling message via the network at a predetermined interval relative to a critical reporting time to the mobile devices; e) means for collecting per-application summaries of the usage information from the mobile terminals in response to the polling message; and f) means for determining per-application usage statistics related to the advertising materials using the summaries.

In another embodiment of the invention, a system includes an ad server having a processor and instructions. The instructions cause the processor to perform steps that include sending the advertising materials to the mobile terminals via the network. Each of the mobile terminals includes a plurality of user applications that render the advertising materials to users. The mobile terminals collect usage information via the user applications. The usage information tracks exposure to the advertising materials associated with each of the user applications. The instructions further cause the processor to collect the summaries of the usage information relative to a critical reporting time from the mobile terminals. The critical reporting time indicates a predetermined milestone in an advertising campaign that uses the advertising materials. The instructions further cause the processor to determine per-application usage statistics related to the advertising materials using the summaries

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIG. 2 is a block diagram illustrating applications polling an ad server according to an embodiment of the invention;

FIGS. 3A-B are diagrams illustrating ad campaign timelines according to embodiments of the invention;

FIG. 4 is a block diagram illustrating various categories of target environments according to an embodiment of the invention;

FIG. 5 is a block diagram illustrating a terminal software architecture according to an embodiment of the invention;

FIG. 6 is a block diagram illustrating gathering and processing usage data according to an embodiment of the invention;

FIG. 7 is block diagram of a mobile computing arrangement according to an embodiment of the invention;

FIG. 8 is block diagram of an ad tracking server arrangement according to an embodiment of the invention; and

FIG. 9 is a flowchart illustrating a method according to an embodiment of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to advertising on mobile devices. Systems, apparatuses and methods are described for leveraging to hardware and software control unique to mobile devices and service providers in order to more accurately track advertising effectiveness. Among other things, a centralized advertising engine may be implemented on device to manage advertisements across multiple applications. In this way, advertising viewing/usage statistics can be gathered and correlated on per-application, per-user basis. This centralized advertising application also allows collecting usage data when the device is offline, and periodically reporting the usage data when the device is back online. This also allows for more control in orchestrating advertising campaigns, and allows tailoring of ad campaigns based on such factors as device type, user nationality, etc.

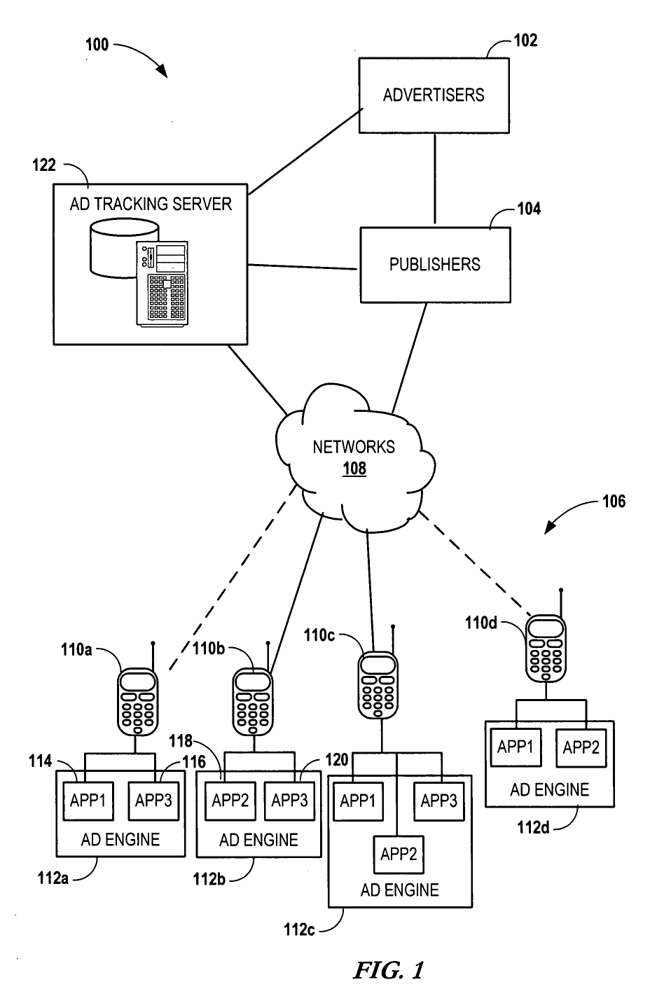

In reference now to FIG. 1, a block diagram illustrates a system 100 according to embodiment of the invention. Generally, the system 100 provides a way for advertisers 102 and publishers 104 to coordinate ad delivery and collect ad exposure data from users 106. The advertisers 102 may include any individuals or entities who wish to buy advertising space. The advertisers 102 may be commercial, governmental, public, private, and/or non-profit entities who wish to communicate with users 106 for a particular purpose. Those purposes may be to promote commercial activity (e.g., selling of goods and services) or for some other purpose (e.g., public service announcements).

The publishers 104 may include those entities that provide sites, applications, or services to users 106. The publications provided by the publishers 104 may be built into the device, or provided in whole or in part via data networks 108. The applications and services may include general-purpose applications such as web browsing, messaging, document creation, etc. The publishers 104 may include software developers, software distributors, resellers, network providers, device manufacturers, or any other entity who may have a presence on user devices. The providers 104 will typically have a base of the users 106 who can potentially be targeted with advertising.

The system 100 provides a way for publishers 104 to provide a pipeline for advertisers 102 to establish a presence with users 106 who utilize sites, applications, and services of the publishers 104. In particular, the system 100 provides a platform for serving ads which can be easily incorporated into applications and services that are visible to the users 106. For purposes of discussion, devices 110a-d are shown as a representative example of mobile devices of particular ones of the users 106. These devices 110a-d may be any mobile communications apparatus known in the art, including phones, PDAs, media players, ultra-mobile PCs, portable navigation devices, etc. The device 110a-d may be part of the same provider network (e.g., cellular service provider, digital messaging network, etc.) or utilize different service providers or provider networks.

Although the devices 110a-d may use different service providers, they may be able to all access the networks 108. The networks 108 may include the public Internet, or some other conglomeration of private or public networks. Generally, the type of publishers 104 that provide the advertising services described herein may dictate the type of networks 108 that the devices 110a-d can commonly access. For example, a publisher 104 may include a cellular or data service provider, and as such the system 100 may rely solely on that provider's network 108. If the publishers 104 include a mobile handset manufacturer, then the networks 108 may include multiple mobile provider networks and/or the public Internet.

Besides being categorized by networks, publishers 104 can also be categorized by content type that they provide. The content type may be related to the underlying subject of the content (e.g., news, sports), the types of applications used to access the content (e.g., Web pages, email) or some other criteria (e.g., membership in a subscription based music service, business affiliations). The content may any type of digital data that can be perceived by the users 106, including text, images, sound, video, location data, etc. The content may be proprietary or rely on public standards, such as Web content.

One reason to consider the type of content provided by the publishers 104 is in order to provide the most appropriate targeting for ads. For example, certain types of media, such as music or video, are not only tied into particular applications and distribution channels, but also have particular subcategories that are important when considering the target audience. Nonetheless, it is becoming more common that a particular type of content can be tied to multiple applications. For example, an enthusiast of a particular arts activity (e.g., music, movies) may be interested in applications that can render media of interest (e.g., sound and video), find data related to that interest (e.g., Web search) and communicate with others who share that interest (e.g., email groups, instant messaging). Therefore, to reach somebody with a particular interest, all the user's activity on a particular device related to that interest may be useful in forming a picture of whether such a person is amenable to a particular advertising campaign, as well as providing feedback as to whether such a person was actually exposed to such a campaign.

In the illustrated system 100, the devices 110a-d each have respective ad engines 112a-d that are associated with one or more applications. The ad engines 112a-d are generally system programs that can generically interface with user programs of the devices 110a-d for purposes of providing, coordinating, and tracking usage of ads. The terminals 110a-d may be differently provisioned, yet still have a common way of providing ad experiences and determining ad viewing or usage. For example, terminal 110a includes applications 114 and 116, and terminal 110b includes application 118 and 120. Applications 116 and 120 may be the substantially the same (e.g., same product and version) and may be included by default on the terminals 110a and 110b. The different applications 114, 118 may also be included by default on the terminals 110a, 110b, or be added later by the user.

The ad engines 112a-d interact via the networks 108 with a tracking server 122. This server 122 is a centralized entity that coordinates the activities of advertisers 102, publishers 104 and end users 106. The advertisers 102 may be able to place orders for ad materials via the server 122, as well as placing the ad content there. The publishers 104 can access this ad material and integrate the material with published content. The ads may be placed on the devices 110a-d directly by the publishers 104 or by the tracking server 122. The tracking server 122 collects ad usage data from the terminals 110a-d, taking into account that the devices 110a-d may not always be connected. This undetermined state of connectivity is represented in FIG. 1 with solid lines indicating currently connected devices (e.g., terminals 110b and 110c) and dashed lines indicating currently disconnected devices (e.g., terminals 110a and 110d).

The use of the ad engines 112a-d and tracking server 122 enables publishers 104 and advertisers to run more coordinated and effective campaigns. For example, publishers 104 may have user data that identifies a target group of users 106. The publishers 104 may wish to focus on those identified users 106 to increase the placement value, thereby potentially increasing cost-per-click (CPC) or cost-per-thousand clicks (CPM). The solutions described herein can accommodate increasing placement value in several ways. The solutions also allow inventory to be accurately forecasted and utilized at the same time. This accuracy can further the publishers' business goals with features such as competitive advertiser rules and campaign priorities. Additionally, publishers can implement self-sponsored campaigns in order to increase retention and drive new usage to services. Publishers can use the sophisticated advertising technology to turn typical users into power users. The reporting will give publishers deep understanding of their user base with the ability to use the new understanding to achieve new levels of user loyalty.

One challenge in running a mobile advertising campaign relates to gathering data/statistics that describes how effective the campaign was. These statistics may relate to whether the ads were actually displayed, how long they were displayed, and whether they resulted in any active and measurable interest from the users (e.g., user interacted to find more information). A system that provides estimates and/or probabilities of these statistics from the client side can, among other things, help to enhance the credibility of in-application advertisement and provide a more accurate basis for fees.

In contrast to mobile device applications, in PC-type applications (like games) are usually online or offline programs. Some PC programs may have both an online and offline mode, however this usually assumes that the online or offline state is long-term. Where a program is online only or in a long-term online mode, offline advertisement mechanisms are not needed. On the other hand, those applications which are either designed to always be offline or are currently operating in a long-term offline mode, they don't need any kind of network logic to handle offline advertisement.

Offline programs typically utilize sponsorship-type advertisement. Sponsorship involves presenting a user experience (e.g., dominant to look and feel, placement of graphics) that is suggestive of the sponsor. Because a sponsorship campaign are somewhat static in regards to it presentation to the user, sponsorships may not have a reason to collect any kind of user data in the program itself. The sponsorship might assume some level of effectiveness using secondary measures, such as units of the sponsored software sold and responses to user questionnaires.

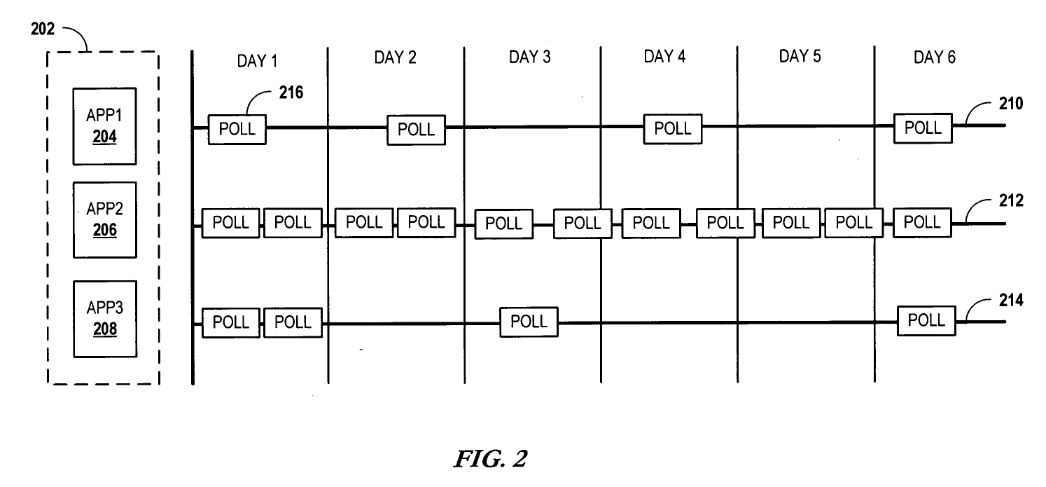

In reference now to FIG. 2, a block diagram illustrates an example of dynamic data gathering according to an embodiment of the invention. An example terminal software environment 202 includes three user applications 204, 206, and 208 that interact with the terminal's user and are capable of delivering some manner of ad material to the user. Further, the applications 204, 206, 208 are configured, either directly or indirectly, to gather statistics as to application usage that exposes the user to advertising materials that may be common to the three applications 204, 206, 208. This usage data is gathered occasionally, whether the device is online or offline, and communicated to a server entity (e.g., tracking server 122 in FIG. 1). The applications 204, 206, 208 may track the usage data individually, or may relay on a common tracking engine (not show) running in the terminal environment 202.

The reporting of user data by the applications 204, 206, 208 to the server is represented by respective timelines 210, 212, 214. For each of the timelines 210, 212, 214, highlighted intervals (e.g., block 216) represent times that the respective applications 204, 206, 208 are reporting usage data to the server. The polling intervals are not necessarily drawn to scale, either with respect to the timelines 210, 212, 214 or with respect to each other. Generally, the polling intervals may correspond to the times that the respective application 204, 206, 208 is in running and interacting with the user, and the polling may be device, application, or server-initiated. The polling interval may be determined based on a predetermined milestone of the ad campaign. For example, polling may begin x-number of days after the ad campaign begins, repeated polling continues every y-number of days after, and polling may be modified or terminated based on the milestone.

The applications 204, 206, 208 may continuously determine user interaction with advertising materials between polling intervals. User interaction may be accurately estimated for some actions such as when user input is applied, although in other cases, the user interaction may be estimated. For example, a foreground application that has user focus may be presumed to be active for a certain amount of time. However, after some point in time it is more likely that the user has stopped interacting (e.g., user was interrupted and left device on).

Generally, the time and frequency of the polling intervals may be tuned based on which of the applications 204, 206, 208 are frequently used. The totality of the polling intervals, when viewed across all applications 204, 206, 208 and when correlated to a particular ad campaign, can provide an accurate representation of the effectiveness of a campaign. The offering provides advertisers with targeted campaigns (across mobile and non-mobile domains) to reach their audience. The campaigns self-optimize, showing the right ads to the right users with the objective to increase response rates. In addition, the platform allows advertisers to fully understand the metrics behind the campaign (e.g. what type of people responded to campaigns, how many people converted, etc.).

The capabilities of such a system may include creative management, including dynamic adaptation of text links and banner advertisements. The form and usage of the different application 204, 206, 208 may facilitate a flexible approach in which materials to provide. For example, if one application is a streaming music service and another application is a browser, both applications might be amendable to and combination of audible, text, and graphical advertisements. However, in some cases it may be less obtrusive to choose one form over another. For example, even though it might be more effective to place voice ads along with music in the streaming music service, if this is a service the user is paying extra for, the user may object to these ads. The user may not, however, object to a graphical ad placed in the display of the music player, in particular if the ad is relevant to what the user is currently listening to. However, if the service is offered free of charge in return for audible ads, then the user may not object to ads between the music. In the case of the browser, an audible ad may be less distracting to the user, who is mostly concentrating on text and images. However, some browsers may also play audio or video media, and the use of an audible or video ad in such a case may or may not be desirable.

Because the terminal environment 202 captures complex interactions between the user and multiple applications 204, 206, 208, ad traffic may be based on flexible business rules that take into account factors such as type of content, type of application, user profile, etc., in order to provide an effective and unobtrusive ad experience. Ads may be dynamically targeted based on categories, profiles or publisher-owned data. An optimizing campaign may be based on the performance of buys, creative or portfolios. The totality of statistics, gathered from a number of terminal environments, may allow for reporting on user impressions, clicks, reach and frequency, return-on-investment (ROI), and post-click actions. Such a campaign may more effectively incorporate features such as frequency capping, creative sequencing, etc.

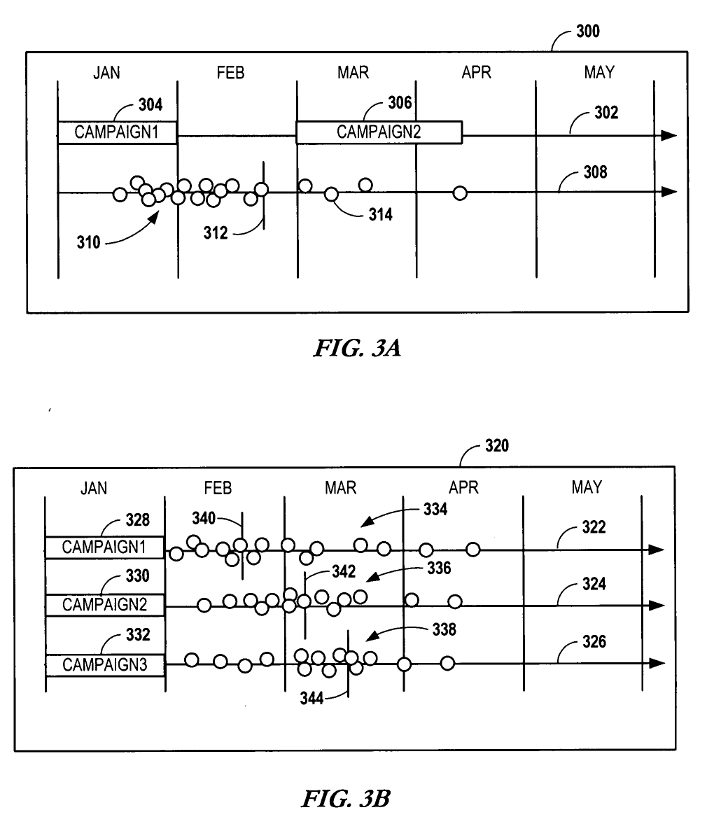

Additional aspects of a targeted ad campaign directed to mobile devices are illustrated in block diagrams in FIGS. 3A-C. The concepts are applicable to any of the ad disbursement and usage data gathering for mobile client/server applications as described herein. An advantage of these advertising systems is that they provide some amount of credibility and predictability when planning in-application advertisement. When in-application advertisement is needed, a placement service can provide advertisers with a more detailed view of campaign effectiveness. Estimation of results may be based on the statistics and business logic and methods which gathers application usage information. Usage information is delivered and used to estimate when the desired target user levels have been reached. Upon reaching the target usage levels, the advertiser requesting the exposure to the target users can be billed.

In FIG. 3A, a block diagram 300 includes a timeline 302 extending over five months. The events on this timeline 302 reflect materials that are sent out to users, such as via applications running on mobile devices. A first ad campaign 304 is run sometime during this period 302 (for example during January), and a second ad campaign is run at a later date 306. The campaigns 304, 306 may be related, such as the introduction of two new products from the same vendor. In another example, the second campaign 306 may be for an add-on or enhancement to a product advertised in the first campaign 304. As such, the information gathered from the first campaign 304 may be useful in fine tuning the second campaign 306.

A timeline 308 runs parallel to timeline 302, and reflects data that is gathered from users who may be at least the target audience of campaigns 304 and/or 306. The circles 310 on timeline 308 indicate user data events related to campaign 304. For example, the circles 310 may when the client application (e.g., game, communications program) has been connected to the server and sent usage and/or viewing statistics. Such an event may also include a server instruction instructing the client device (e.g., via the hosting application or via a dedicated ad engine) to change some aspect of the ads, such as by using a different in-application banner. Generally, it would take some time for these events to be detected and sent back to the server, therefore the events 310 may typically lag the actual campaign 304 itself.

There may be a point 312 in the data gathering timeline 308 where a critical mass is reached (for example 80% of the clients reported back) or some other pre-defined milestone in the advertising campaign is reached. This data can be used for billing the client. It will be appreciated that additional events (e.g., event 314) may be seen after this critical point 312 is reached, and this later data may still be useful in providing feedback and adjusting billing, statistics, etc. The use of the feedback data 310 can bring more predictability to both the current ad campaign 304, and can be used to improve campaign quality of both the current campaign 304 and future campaigns 306.

It will be appreciated that the actual value selected for the critical point 312 will often be an estimate based on such factors as number of users, number of handsets in use, etc. In order to better gauge the size of the user base, and in particular per-application usage of those users, the ad engines on the devices may operate in a “silent” mode where application and device usage is monitored for the purposes of determining a baseline data point. For example, one or more service identifiers may be associated with each application on a device, and the usage data based on those service identifiers could be tracked over time. This data may be augmented by other sources, such as predicted new subscription rates, attrition rates, software sales of new or upgraded applications, etc.

The distribution and content of the user feedback data 310 may vary depending on the type of applications used to render the ads, the user base to which the ads are targeted, the type of devices to which the ads are sent, etc. An example of this variability is shown in the diagram 320 in FIG. 3B. In this diagram, three timelines 322, 324, 326 are used to represent three substantially simultaneous campaigns, 328, 330, and 332, respectively. In response to the campaigns 328, 330, 332, different distributions of feedback data are collected, as represented by circles 334, 336, and 338, respectively.

The distributions 334, 336, 338 have reached a critical point at different times, as represented by respective markers 340, 342, and 344. These differences between the critical points 340, 342, 344 may be due to random chance, or be a function of the users, devices, networks, applications used to present the ads, types of ads media, types of products or services advertised, and any other factor. By utilizing data included in the feedback events 334, 336, 338, a correlation between these factors can be determined, and these and future campaigns can be adjusted to determine the desired effect. For example, some campaigns may desire the earliest feedback response, as represented by point 340 with data set 334. By analyzing the factors that provided this campaign 328 with early feedback, such factors may be incorporated into future campaigns.

The distributions 334, 336, 338 may also be used to provided multiple levels of usage tracking within the same campaign. For example, the campaigns 328, 330, and 332 may be substantially the same, except targeted to different demographics of users. As such there may be multiple critical reporting values 340, 342, 344 associated with each of the demographics. As such, a tiered cost structure could be implemented that relies on the critical points 340, 342, 344 being reached for multiple demographic groups.

As may be appreciated, the critical reporting values 340, 342, 344 may be defined as any combination of users or time. For example, in one embodiment a critical reporting number may be based on the estimated usage data (e.g., data 310 in FIG. 3A) and indicates a certain number of users that satisfy some criteria. The criteria may be a target number desired by an advertiser, an “inflection” point where collection of usage data obtains a certain rate of change (e.g., maximum, increasing/decreasing at a certain rate), etc. An advertising campaign can be stopped based on collecting the usage data from a number of users that satisfies the critical reporting number. The estimated usage data may also be used to estimate/defining critical reporting values 340, 342, 344 as critical reporting times. The critical reporting time indicates a time past which there is a change in likelihood of collecting additional usage data and an advertising campaign can be automatically stopped based on the critical time. For example, defining the critical reporting time may involve defining the critical reporting time as a time as some percentage (e.g., 80%) of the usage data of all users will be collected.

It will be appreciated that there may be many modifications and embodiments to the use of critical reporting values. For example, data collected over time may be used to spot trends and may be used to adjust critical reporting numbers. For example, if collected data indicates interest is greater than anticipated, it may be worthwhile to increase one or more critical values in order to take advantage of this. In one further embodiment the critical reporting numbers for a given campaign may be defined as a plurality of critical reporting times, each associated with a different demographic. In such a case, stopping the advertising campaign based on the critical time may involve stopping each of the plurality of critical reporting times based on a different criteria associated with each of the plurality of critical reporting times. For example, a critical value of 80% of estimated users may be defined for a desired demographic, and a lower value (e.g., 40%) may be defined for users outside that demographic. This can result it different critical numbers and/or times for each demographic.

The methods and systems described herein enable advertisers and publishers to investigate different kind of approaches using advertising that is coordinated among multiple applications. Other factors may also be considered with application type usage information, including language, language groups, countries, phone models, etc., that are characteristics of the end users. Some aspects of the present invention deal with in-application and in-games usage detection, where each client application will be detected with one or more levels so, that different kind of dynamic levels for different purposes can be detected and automatically used when in-application campaigns are launched. These dynamic levels may be based on composition of user groups (e.g., demographics as described above), particular uses of an application (e.g., particular levels/locations) of an online virtual reality game, or other factors as discussed in greater detail herein.

A multi-application advertising approach is particularly useful in the mobile data processing and communications environment. The average lifecycle of mobile devices is typically much shorter than that of personal computers. Hardware, software, and services are often more tightly integrated in mobile devices than is typical in the PC market. As a result, the device manufacturers and mobile service providers have greater control over the user experience than is typical for general purpose computers. This control of the platform, as well as the highly personalized nature of mobile devices, allows providers and manufacturers to more accurately determine who owns what model terminals and how those terminals are configured/provisioned. This provides an opportunity to design very targeted advertising campaigns.

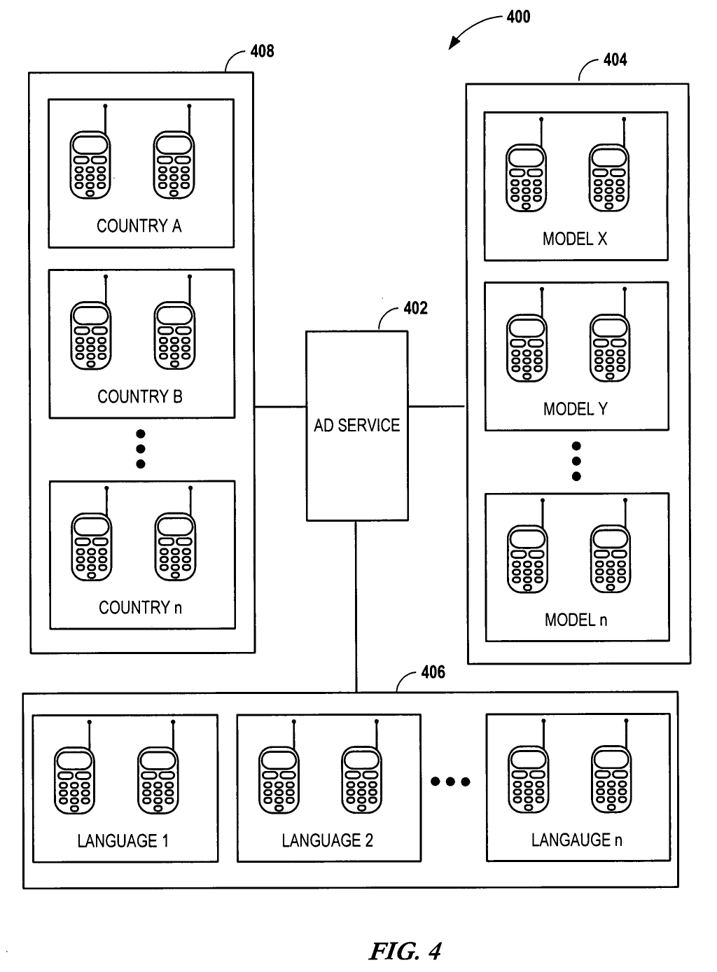

In reference now to FIG. 4, a block diagram 400 indicates an organizational level view of an advertising platform according to an embodiment of the invention. Generally, an ad service 402 is capable of detecting model and language of mobile terminals, as represented by terminal groups 404 and 406, respectively. These two variables 404, 406 are typically static for a given user. The service 402 also detects country 408 of terminals, which may be a country of origin of the user, or a country in which a given terminal is currently operating. In the latter case, the country 408 may be a variable, particularly when the user is a frequent international traveler who uses a device that is capable of connecting to foreign networks.

The service 402 may act as a centralized entity capable of sending out ad materials (e.g., banner advertisements) to terminals. When determining the content of the ads, the service may dynamically detect country information 408 and tailor advertising based on the countries. Some aspects of the advertisement may also be selected based on model type 404. The model type 404 is particularly useful in providing acceptable media formats (e.g., size, color, resolution). It will be appreciated that any given device may be placed in a subcategory of the illustrated categories 404, 406, 408 at the same time. For example, a single device may be in Country A, Model Y, and Language 1 categories, all at the same time. Thus the categories 404, 406, 408 may be considered in combination or separately. It will be appreciated that these categories 404, 406, 408 are provided for purposes of illustration, and other categories may be used in addition to or instead of those illustrated. Such other categories may include service providers, user characteristics (e.g., age, gender), bearer types (e.g., GSM, CDMA), etc.

The ad service 402 may have a priori knowledge of the classification of a particular device within each of the categories. For example, language 406 may be initially configured from the factory, and if it is changed at all, will generally be changed when the user first receives the device. The device model 404 may be known from sales or account records of customers, or may be determined using data stored on the device and/or retrievable from the device. Country 408 may be determined statically (e.g., customer records) or dynamically (e.g., location of last base station connected to). With this type of information readily available, the ad service 402 can provide country specified maps, which can automatically be used for providing terminal renewal campaigns to maximize campaign efficiency.

The ad service 402 may be used by the terminal manufacturer to efficiently and automatically promote their own terminal marketing and mobile advertising. Particular implementations of the service 402 can be extended to other mobile site to other commercial entities, such as device/peripheral manufacturers and service providers. One advantage that the mobile device manufacturer has in implementing this type of service is relatively strong control over hardware and software configurations of the mobile devices.

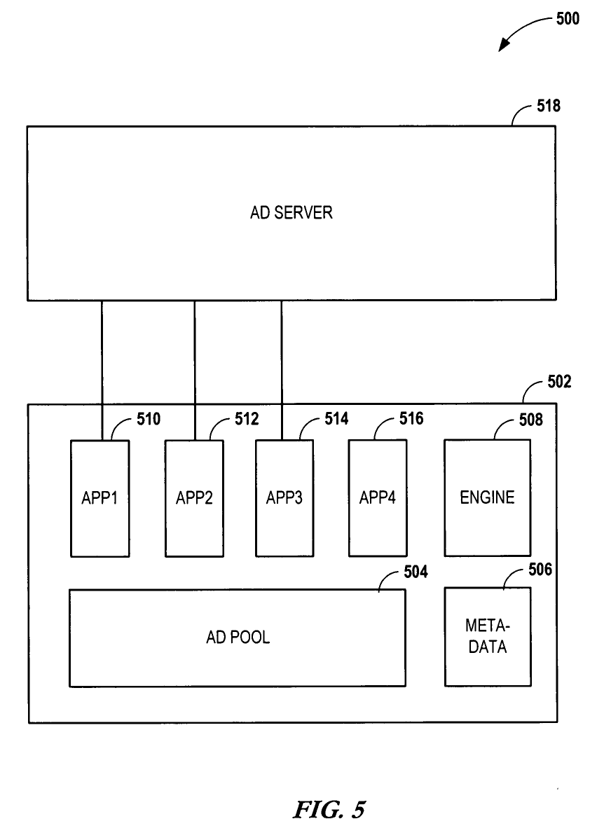

In reference now to FIG. 5, a block diagram 500 illustrates a mobile device architecture according to an embodiment of the invention. An application framework 502 is implemented in a mobile device. The application framework 502 may be pre-installed and integrated with the operating system, or be added as an application level service or program. The framework 502 allows an entity in the product distribution chain (e.g., manufacturer, retailer, service provider, etc.) to place in-house ads and/or place ads for a third party. Generally the framework 502 provides a single consistent and generic way to implement advertising in a plurality of applications.

The framework 502 may be preconfigured with an ad pool 504 and metadata 506. The ad pool 504 stores media related to ads used by the framework 502. The ad pool 504 may also store data related to the ads, such as hyperlinks used to access further information, time signatures for start/end of ad campaigns, display parameters, etc. This ad specific data may also be store with the metadata 506. The metadata 506 also tracks data related to the user and/or device. For example, the metadata 506 may include environmental information that can vary depending on where the phone has been taken during use.

The framework 502 includes an engine 508 which provides the business and application logic of the framework 502. The engine 508 may be capable of being simultaneously couple to multiple applications, here represented as applications 510, 512, 514, and 516. The engine 508 efficiently coordinates interactions between the applications 510, 512, 514, 516 and other components of the architecture 502, such as the ad pool 504 and metadata 506. The engine 508 may also facilitate communication between individual applications 510, 512, 514, 516 and network service entities as represented by ad-server 518.

Although each application 510, 512, 514, 516 may be able to communicate the ad server 518 separately, it may be more efficient to channel all communications with the server 518 through the engine 508. The engine 508 may already be capable of recognizing what kind of applications there are in the system 502, and use that information to update the ad pool 504, update metadata 506, and make other system configurations related to the particular applications 510, 512, 514, 516 (e.g., create special directories, permissions, registry entries, interprocess-communications structures, etc.) Typically, each application 510, 512, 514, 516 registers with the ad engine 508 at one or both of installation time and/or run time.

All the applications 510, 512, 514, 516 may be capable of performing some sort of ad serving/rendering, typically using an ad particularly suited to the application. Thus, when applications 510 and 512 are both used to ads directed to the same (or similar) content, each application 510, 512 may generate a different kind of result. The applications 510, 512, 514, 516 may render ads and collect usage data when the associated device is both online or offline. The framework 502 may need sophisticated algorithms to determine when network conditions are available, favorable. The framework 502 also require a robust data transfer model to deal with intermittent connections, and also provide a sophisticated user interface for configuring preferences and ensuring compliance with restriction, security, and privacy rules.

Because the client-to-server communications of the framework 502 may need to be flexible and robust, it may be preferable to implement such communication functionality in the ad engine 508 or some other centralized component. In such an implementation, the ad engine 508 can aggregate usage data collected by the applications 510, check for connectivity/polling signals, and send relevant data to the server 518 in the most unobtrusive way possible. The engine 508 in such an arrangement may also check the stats from both metadata 506 and ad pool 504 databases, and contact the server 518 to obtain update data for both databases 504, 506.

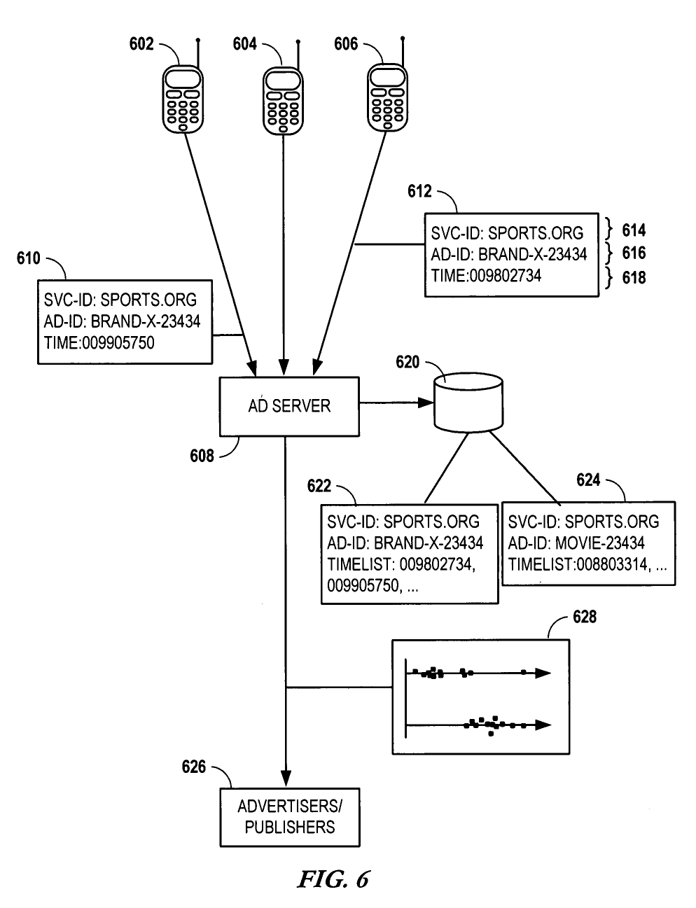

In reference now to FIG. 6, a block diagram illustrates an example of usage data that may be collected and analyzed in a system according to an embodiment of the invention. Mobile terminals 602, 604, 606 are configured to render ads, track usage data related to the ads, and report the usage data to an ad server 608. An example of individual usage data is represented by usage messages 610, 612. As indicated in message 612, usage data may include a service identifier 614, an ad identifier 616, and a time stamp 618. The time stamp 618 may indicate one or more of a time the ad was viewed and a time that the device connects to an ad server to upload usage data.

The service identifier 614 is used to indicate the type of service and/or application which delivered/rendered the particular ad. In some cases, there may be a one-to-one correspondence between the service identifier 614 and an application of the associated terminal 606. In other cases, an application of the terminal may have multiple service identifiers 614, each associated with a different aspect of that application's use. For example, the service identifier 614 may correspond to a local or network uniform resource identifier (URI), data type, operating mode of the application, etc.

The ad identifier 616 indicates a particular ad, ad campaign, and/or ad material that is rendered to the user via the associated terminal 606. Some or all of the ad identifier 616 may be common to a number of different applications, even though the underlying ad material may be rendered in quite different ways among the different applications. The time stamp 618 provides an indicator of at least when the user of the terminal 606 may have had the ad material presented to them. The time stamp 618 may be simple data/time integer, or may include additional data, such as how long the user may have been exposed to the ad, local time zone, etc. The illustrated data values 614, 616, 618 are merely exemplary, and many variations are possible. For example, the messages 610, 612 may contain (either required or optional) additional user actions in response to the ad, other hardware/software states of the terminal at the time the ad was viewed, location data at the time the ad was viewed (e.g., via GPS or base station identification), user identifier, etc.

The ad server 608 receives a large number of such messages 610, 612 and places the usage data in a database 620. The messages 610, 612 may be stored as is, or condensed, as represented by database records 622, 624. For example, database record 622 includes the redundant service identifiers and ad identifiers of messages 610, 612, and the times of the messages 610, 612 are included as a list. Record 624 has the same service identifier as record 622, but a different ad identifier, therefore would be stored separately. These examples of records 622, 624 are provided for purposes of example. The design of database structures (e.g., tables of a relational database) may be dependent on many factors, including the type of data ultimately collected from the terminals 602, 604, 606, performance requirements, etc. The database 620 may also be able to correlate data received from the terminals 602, 604, 606 with other databases, such as demographic data of the terminal users. Such correlation may involve “cleansing” data to prevent usage data from being tied to a user identity, data verification, etc.

Periodically, the ad server 608 may report out data to advertisers/publishers 626, as represented by report 628. Typically, the report data 628 is a reduced set of collected data that is relevant to a particular advertiser/publisher 626, and may be processed to prevent revealing user's private data, competitor's data, etc. The report data 628 may be provided at intervals or updated in near-real time. The report data 628 may include criteria for estimating critical penetration of a particular ad campaign and indication that the penetration has been reached based on some predetermined criteria (e.g., reached 80% of estimated target users).

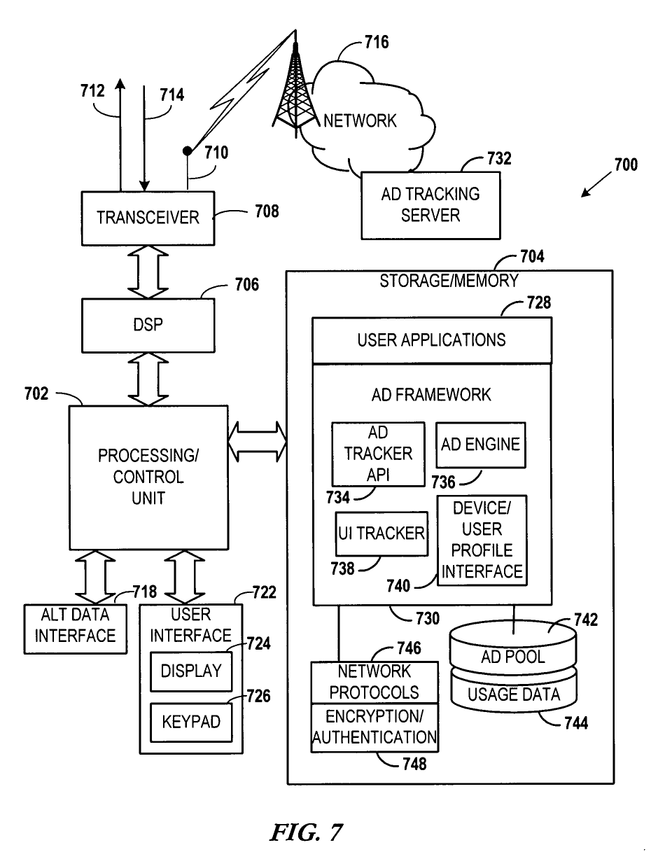

Many types of apparatuses may be able participate in advertising campaigns as described herein. Mobile devices are particularly useful in this role. In reference now to FIG. 7, an example is illustrated of a representative mobile computing arrangement 700 capable of carrying out operations in accordance with embodiments of the invention. Those skilled in the art will appreciate that the exemplary mobile computing arrangement 700 is merely representative of general functions that may be associated with such mobile devices, and also that landline computing systems similarly include computing circuitry to perform such operations.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 includes wireless data transmission circuitry for performing network data exchanges.

This wireless circuitry includes a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 708, generally coupled to an antenna 710, transmits the outgoing radio signals 712 and receives the incoming radio signals 714 associated with the wireless device.

The incoming and outgoing radio signals 712, 714 are used to communicate with a mobile service provider network 716. The network 716 may include any voice and data communications infrastructure known in the art, including CDMA, W-CDMA, GSM, EDGE, etc. The network 716 typically provides access to traditional landline data infrastructures, including IP networks such as the Internet. The mobile computing arrangement 700 may also include an alternate network/data interface 718 capable of accessing a local network (not shown). The alternate data interface 718 may incorporate combinations of I/O and network standards such as USB, Bluetooth, Ethernet, 802.11 Wi-Fi, IRDA, etc.

The processor 702 is also coupled to user-interface elements 722 associated with the mobile terminal. The user-interface 722 of the mobile terminal may include, for example, a display 724 such as a liquid crystal display. Other user-interface mechanisms may be included in the interface 722, such as keypads 726, speakers, microphones, voice commands, switches, touch pad/screen, graphical user interface using a pointing device, trackball, joystick, etc. These and other user-interface components are coupled to the processor 702 as is known in the art.

The program storage/memory 704 typically includes operating systems and programs for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 704 of the mobile computing arrangement 700 may also include software modules for performing functions according to embodiments of the present invention.

In particular, the program storage/memory 704 may include user applications 728 capable of rendering ads to users via the user interface 722. The applications 728 are coupled to an ad framework 730 that manages interactions between the applications 728 and an ad tracking server 732 accessible via the network 716. The ad framework 730 may include an application program interface (API) 734 that is commonly accessible by all of the applications 728. The API 734 may exist as a shared library or be implemented as a run-time interface module. In the latter case, the applications 728 may use a run-time interprocess communications (IPC) mechanism, such as pipes, sockets, streams, or middleware IPC software (e.g., CORBA, Java RMI, etc.) to access the API 734.

An ad engine 736 of the framework 730 handles core tasks such as providing ad materials to the applications 728 via the API 734 and collecting usage data from applications 728 via the API 734. The ad engine 736 may provide other services indirectly related to providing the ad material, such as localization of text (e.g., selecting appropriate languages and character sets), reformatting graphics, transcoding streaming media, etc.

The primary sources of usage data received at the ad engine 736 are the applications 728 themselves; however other user interface data may be useful. For example, even though an application in a multi-window environment is rendering an ad, the ad may not be viewable if another application window is covering the ad. Therefore the ad engine 736 may monitor other user interface data, such as via user interface (UI) tracker component 738, to more accurately gauge usage/exposure. Other data that may be collected by the ad engine 736 that may be outside the scope of the applications 728 includes data that describes device configurations and user data. Therefore, the framework 730 may include a profile interface 740 to allow the ad engine 736 to access this local data and include selected parts of the profile data with the usage statistics.

The ad engine 736 may require some access to persistent storage, as represented by ad pool database 742 and usage database 744. The ad pool 742 may contain ad materials and metadata related to the materials, such as data/time to show, repetitions, target applications, etc. The usage database 744 contains data that is collected during and after the ads have been rendered. The usage database 744 may also contain indicators that ads were never rendered, such as where the user never opened the target application, actively blocked the rendering of ads, etc.

The ad engine 736 generally submits summaries of the usage data 744 to the ad tracking server 732. These submissions may be initiated by the mobile arrangement 700 and/or in response to polling from the ad tracking server 732. The submissions are generally scheduled at predetermined intervals that can be selected to balance the need for timely updates of usage data 744 at the server with the possible intermittent nature of the arrangement's network connectivity and possible degradation of network and processor performance resulting from the submission. The submission of data to the server 732 may use standard network protocols, as indicated by protocol stack 746. Other features may be needed to protect the usage data 744 being viewed by unauthorized entities. For example, an encryption/authentication module 748 can be used to make transmitted usage data 744 unreadable by third parties, and ensure that the ad engine 736 only sends the data 744 to authenticated entities.

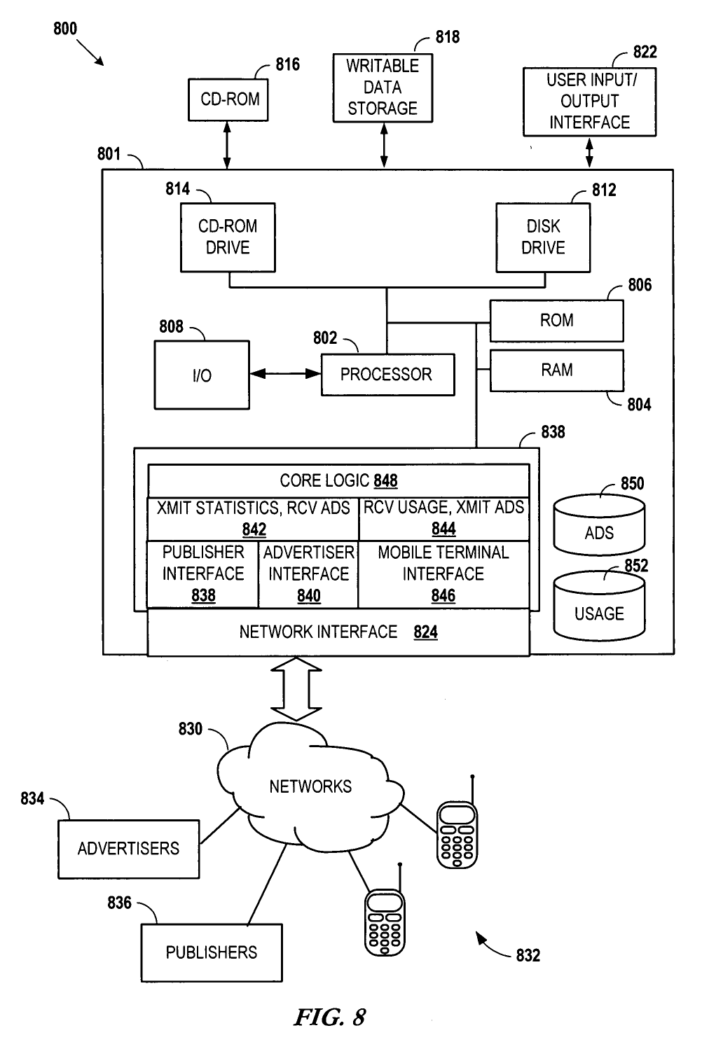

An ad distribution and tracking system as described herein can be implemented using one or more network servers to coordinate ad distribution and manage collection of usage data. In reference now to FIG. 8, a block diagram illustrates an example ad tracking server 800 according to an embodiment of the invention. The ad tracking server 800 includes a computing arrangement 801. The computing arrangement 801 may include custom or general-purpose electronic components. The computing arrangement 801 includes a central processor (CPU) 802 that may be coupled to random access memory (RAM) 804 and/or read-only memory (ROM) 806. The ROM 806 may include various types of storage media, such as programmable ROM (PROM), erasable PROM (EPROM), etc. The processor 802 may communicate with other internal and external components through input/output (I/O) circuitry 808. The processor 802 carries out a variety of functions as is known in the art, as dictated by software and/or firmware instructions.

The computing arrangement 801 may include one or more data storage devices, including disk drives 812, CD-ROM drives 814, and other hardware capable of reading and/or storing information such as DVD, etc. In one embodiment, software for carrying out the operations in accordance with the present invention may be stored and distributed on a CD-ROM 816, writable data storage media 818 or other form of media capable of portably storing information, including magnetic media, flash memory, etc. These storage media may be inserted into, and read by, devices such as the CD-ROM drive 814, the disk drive 812, I/O ports 808, etc. The software may also be transmitted to computing arrangement 801 via data signals, such as being downloaded electronically via a network, such as the Internet 830. The computing arrangement 801 may be coupled to a user input/output interface 822 for user interaction. The user input/output interface 822 may include apparatus such as a mouse, keyboard, microphone, touch pad, touch screen, voice-recognition system, monitor, LED display, LCD display, etc.

The computing arrangement 801 may be coupled to other computing devices via networks. In particular, the computing arrangement includes a network interface 824 for communicating with networks 830. The network interface 824 may include a combination of hardware and software components, including media access circuitry, drivers, programs, and protocol modules. The networks 830 may include any combination of private or public networks such as the Internet. The networks 830 allow the computing arrangement 801 to communicate with entities such as user terminals 832, advertisers 834, and publishers 836.

The computing arrangement 801 includes processor executable instructions 838 for carrying out ad management tasks of the computing arrangement 801. These instructions 832 may include interfaces 838, 840 for communicating with respective publishers 836 and advertisers 834. The advertiser interface 840 may allow advertisers 834 to upload advertising materials and parameters related to an ad campaign. The publisher interface 838 may allow publishers 836 to define published materials targeted for ads, verify ad insertion, etc. Both interfaces 838, 840 may be able to send relevant usage statistics to the associated entities 836, 834 as defined by particular technical business agreements. This “pull” of ads by the server 800 and “push” of statistics to ad entities 834, 836 is represented by functional component 842.

The server 800 performs an inverse function with the terminal devices 832, namely receiving data from terminal devices 832 and sending ad materials to terminal devices 832, and this function is represented by component 844. The communications with individual devices is handled by a mobile terminal interface 846, which may need to take into account a wide variety of device types, device software, operator networks, and other factors needed to effectively communicate with the divers community of mobile user. It will be appreciated that the server 800 may perform significant transformation of data between ad generation entities 834, 836 and users 832, and this functionality is represented by the core logic module 848.

The core logic module 848 may collect, categorize, format, and otherwise process ad data as required by the various target devices 832. The core logic module 848 may maintain the ad data in a database 850. The core logic module 848 also gathers raw usage data from the mobile devices 832. This usage data may be correlated, conditioned, transformed, and stored in a usage database 852. Thereafter, statistical summaries and target values can be monitored by the core logic module 848 and communicated to the interested players 834, 836.

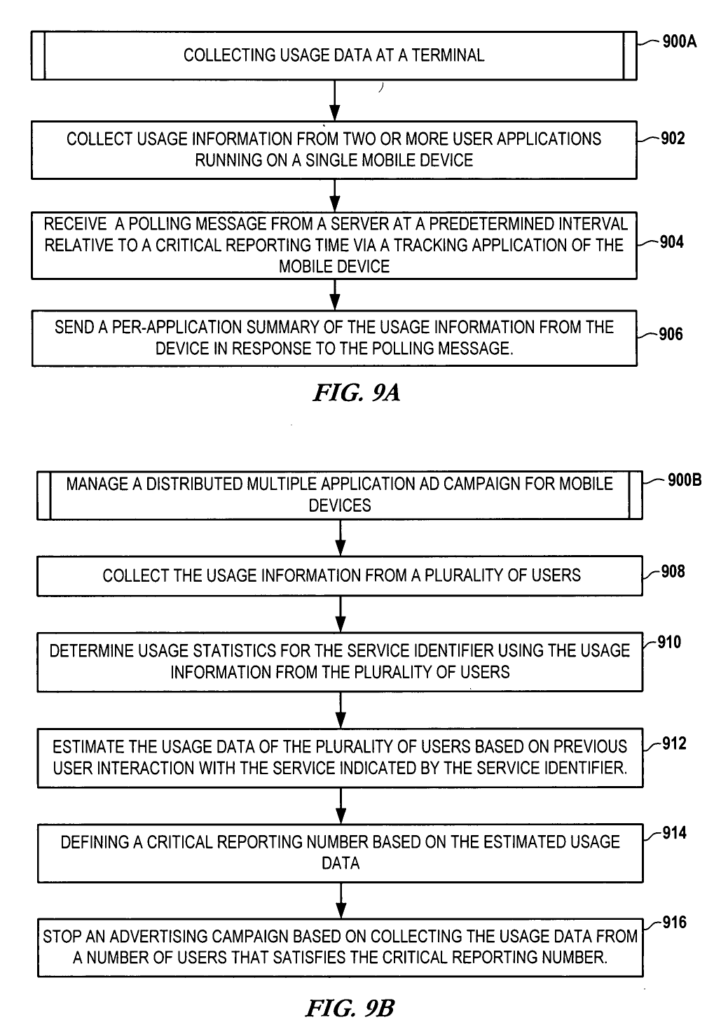

In reference now to FIG. 9A, a flowchart illustrates a procedure 900A for collecting usage data at terminals according to an embodiment of the invention. Usage information is collected 902 from two or more user applications running on a single mobile device. The usage information tracks exposure to advertising materials associated with each of the user applications. A polling message from a server is received 904 at a predetermined interval relative to a critical reporting time via a tracking application of the mobile device. The critical reporting time indicates a predetermined milestone in an advertising campaign that uses the advertising materials. The milestone may indicate, for example, an inflection point in usage data over time, a contractual milestone agreed upon between advertiser and provider, natural termination of a campaign (e.g., holiday campaign), etc. A per-application summary of the usage information is sent 906 from the mobile device in response to the polling message.

A flowchart in FIG. 9B illustrates a system level procedure 900B for managing a distributed multiple application ad campaign for mobile devices according to an embodiment of the invention. The usage information is collected 908 from a plurality of users (e.g., such as shown in FIG. 9A). Usage statistics for a service identifier are determined 910 using the usage information from the plurality of users. The service identifier is associated with an application of the terminals, and in particular a service used by the application. The usage data of the plurality of users may be estimated 912 based on previous user interaction with the service indicated by the service identifier. A critical reporting number is determined 914 based on the estimated usage data, and an advertising campaign is stopped 916 based on collecting the usage data from a number of users that satisfies the critical reporting number.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
collecting usage information from two or more user applications running on a single mobile device, wherein the usage information tracks exposure to advertising materials associated with each of the user applications;
receiving a polling message from a server at a predetermined interval relative to a critical reporting time via a tracking application of the mobile device, wherein the critical reporting time indicates a predetermined milestone in an advertising campaign that uses the advertising materials; and
sending a per-application summary of the usage information from the mobile device in response to the polling message.

2. The method of claim 1, wherein the usage information is collected during a predetermined time period after a start of the advertising campaign.

3. The method of claim 1, wherein the usage information includes a service identifier that indicates a service used by the user applications, an ad identifier that indicates an advertisement associated with the service, and a time of user exposure to the advertisement.

4. The method of claim 3, further comprising:
collecting the usage information from a plurality of users;
determining usage statistics for the service identifier using the usage information from the plurality of users.

5. The method of claim 4, further comprising estimating the usage data of the plurality of users based on previous user interaction with the service indicated by the service identifier.

6. The method of claim 5, further comprising:
defining the critical reporting time based on the estimated usage data, wherein the critical reporting time indicates a time past which there is a change in likelihood of collecting additional usage data; and
stopping the advertising campaign based on the critical time.

7. The method of claim 6, wherein defining the critical reporting time comprises defining the critical reporting time as a time when 80% of the usage data of all users will be collected.

8. The method of claim 6, wherein defining the critical reporting time comprises defining a plurality of critical reporting times, each critical reporting time associated with a different demographic.

9. The method of claim 8, wherein stopping the advertising campaign based on the critical time comprises stopping each of the plurality of critical reporting times based on a different criteria associated with each of the plurality of critical reporting times.

10. The method of claim 5, further comprising:
defining a critical reporting number based on the estimated usage data; and
stopping the advertising campaign based on collecting the usage data from a number of users that satisfies the critical reporting number.

11. The method of claim 10, wherein defining the critical reporting number based on the estimated usage data comprises defining a plurality of critical reporting numbers each associated with separate demographics, and wherein the advertising campaign is stopped based on receiving usage data from a number of users of each of the demographics that satisfies the associated critical reporting number.

12. The method of claim 1, wherein the usage data includes at least one of country identifier and language identifier of the mobile device.

13. The method of claim 1, wherein the usage data includes a terminal model identifier.

14. The method of claim 1, wherein at least one of the user applications comprises a computer game.

15. A mobile device comprising:
a network interface capable of connecting to a network;
a processor coupled to the network interface; and
memory coupled to the processor, the memory including a plurality of user applications and an ad engine having instructions that causes the processor to perform steps that include:
causing the user applications to render advertising materials to a user of the device;
collecting usage information via the user applications, wherein the usage information tracks exposure to the advertising materials associated with each of the user applications;
receiving a polling message relative to a critical reporting time via the network at a predetermined interval, wherein the critical reporting time indicates a predetermined milestone in an advertising campaign that uses the advertising materials; and
sending a per-application summary of the usage information from the device in response to the polling message.

16. The mobile device of claim 15, wherein the usage information includes a service identifier that indicates services used by the user applications, an ad identifier that indicates an advertisement associated with the service, and a time of user exposure to the advertisement.

17. The mobile device of claim 15, wherein the usage data includes at least one of country identifier and language identifier of the mobile device.

18. The mobile device of claim 15, wherein the usage data includes a terminal model identifier.

19. The mobile device of claim 15, wherein at least one of the user applications comprises a computer game.

20. A computer-readable storage medium having instructions executable by a processor of a mobile device for performing steps comprising:
causing two or more user applications of the mobile device to render advertising materials to a user of the device;
collecting usage information via the user applications, wherein the usage information tracks user exposure to the advertising materials associated with each of the user applications;
receiving a polling message relative to critical reporting time via the network at a predetermined interval, wherein the critical reporting time indicates a predetermined milestone in an advertising campaign that uses the advertising materials; and
sending a per-application summary of the usage information from the device in response to the polling message.

21. A system comprising:
a network;
a plurality of mobile terminals, each including a processor, a plurality of user applications, and an ad engine having instructions that cause the processor to perform steps that include:
causing the user applications to render advertising materials to a user of the mobile terminal;
collecting usage information via the user applications, wherein the usage information tracks exposure to the advertising materials associated with each of the user applications;
receiving a polling message relative to a critical reporting time via the network at a predetermined interval, wherein the critical reporting time indicates a predetermined milestone in an advertising campaign that uses the advertising materials; and
sending a per-application summary of the usage information from the mobile terminal in response to the polling message; and
an ad server having a processor and instructions that cause the processor to perform steps that include:
sending the advertising materials to the mobile terminals via the network;
collecting the summaries of the usage information from the mobile terminals via the network; and
determining per-application usage statistics related to the advertising materials using the summaries.

22. The system of claim 21, wherein the mobile terminals collect the usage information during a predetermined time period after a start of an advertising campaign directed to the mobile terminals.

23. The system of claim 21, wherein the usage information includes a service identifier that indicates a service used by the user applications, an ad identifier that indicates an advertisement associated with the service, and a time of user exposure to the advertisement.

24. The system of claim 21, where the ad server has instructions that further cause the processor to estimate the usage data of the plurality of mobile terminals based on previous user interaction with one or more of the user applications.

25. The system of claim 24, where the ad server has instructions that further cause the processor to:
define a critical reporting number based on the estimated usage data; and
direct the mobile terminals to stop an advertising campaign based on collecting the usage data from a number of users that satisfies the critical reporting number.

26. The system of claim 25, wherein defining the critical reporting number based on the estimated usage data comprises defining a plurality of critical reporting numbers each associated with separate demographics, and wherein the advertising campaign is stopped based on receiving usage data from a number of users of each of the demographics that satisfies the associated critical reporting number.

27. A system comprising:
means for sending advertising materials to a plurality of mobile terminals via the network;
means for causing a plurality of user applications of the mobile terminals to render the advertising materials to users of the mobile terminals;
means for collecting usage information via the user applications, wherein the usage information tracks exposure to the advertising materials associated with each of the user applications;
means for sending polling messages via the network at predetermined intervals to the mobile terminals;
means for collecting summaries of the usage information from the mobile terminals in response to the polling messages relative to a critical reporting time; and
means for determining per-application usage statistics related to the advertising materials using the summaries.

28. An ad server having a processor and instructions that cause the processor to perform steps that include:
sending polling messages to mobile terminals via a network when the mobile terminals are connected to the network, wherein each of the mobile terminals includes a plurality of user applications that render advertising materials to users, and wherein the mobile terminals collect application-specific usage information via the user applications, wherein the application-specific usage information tracks exposure to the advertising materials associated with each of the user applications;
collecting the application-specific usage information from the mobile terminals via the network in response to the polling messages, wherein the application-specific usage information includes at least one of a service id, an advertisement id, and a time of connection; and
calculating, based on the application-specific usage information, per-application usage statistics related to the advertising materials within a critical time relative to a predetermined milestone of an advertising campaign that uses the advertising materials.

29. A method comprising:
collecting application-specific information from two or more user applications running on a single mobile device, wherein the application-specific usage information tracks exposure to advertising materials associated with each of the user applications and includes at least one of a service id, an advertisement id, and a time of connection;
sending a polling message to the mobile device via a network when the mobile device is connected to the network;
receiving the application-specific usage information from the mobile device in response to the polling message; and
calculating, based on the application-specific usage information, per-application usage statistics within a critical time relative to a predetermined milestone of an advertising campaign that uses the advertising materials.
